(19) United States
(12) Patent Application Publication
(10) Pub. No.: US 2021/0397399 A1
(43) Pub. Date: Dec. 23, 2021

(54) INTERFACES MOVES

(71) Applicant: Hewlett-Packard Development Company, L.P., Spring, TX (US)

(72) Inventors: Ron Yirang Zhang, Fort Collins, CO (US); Lu-Yen Lai, Taipei (TW); Wei-Yu Lin, Taipei (TW); Dhruv Jain, Mississauga (CA); Cheng-Tsung Wu, Taipei (TW)

(73) Assignee: Hewlett-Packard Development Company, L.P., Spring, TX (US)

(21) Appl. No.: 17/054,185

(22) PCT Filed: Mar. 12, 2019
(86) PCT No.: PCT/US2019/021798

§ 371 Date: Nov. 10, 2020

(51) Int. Cl. G06F 3/14; G06F 3/0486; G06F 3/02

(52) U.S. Cl. CPC G06F 3/1446; G06F 2203/04803; G06F 3/02; G06F 3/0486

(57) ABSTRACT

An example non-transitory computer-readable storage medium comprises instructions that, when executed by a processing resource of a computing device, cause the processing resource to determine a portion of an interface moved from a first display to a second display. The instructions further cause the processing resource to compare the portion of the interface moved from the first display to the second display to a threshold. The instructions further cause the processing resource to move the interface automatically from the first display to the second display responsive to a determination that the portion of the interface moved to the second display exceeds the threshold.

### BACKGROUND

Many computing devices and other electronic devices, such as mobile phones, desktop and laptop computers, tablets, digital cameras, and other similar devices execute applications and present content, such as user interfaces for the applications, on displays.

### BRIEF DESCRIPTION OF THE DRAWINGS

The following detailed description references the drawings, in which:

FIG. 1 depicts a computing device having a first display and a second display to present an interface according to examples described herein;

FIG. 2 depicts a computing device to present an interface on a first display and on a second display according to examples described herein;

FIG. 3 depicts a computer-readable storage medium comprising instructions to present an interface on a first display and on a second display according to examples described herein;

FIG. 4 depicts a flow diagram of a method that presents an interface on a first display and on a second display according to examples described herein;

FIGS. 5A and 5B depict the first display and the second display of FIG. 1 to present an interface according to examples described herein;

FIG. 6 depicts a flow diagram of a method that presents interfaces on a first display and on a first display and on a second display according to examples described herein; and

FIGS. 7A, 7B, and 7C depict the first display and the second display of FIG. 2 to present interfaces according to examples described herein.

### DETAILED DESCRIPTION

Multiple displays continue to be a desirable feature to users of computing devices and other electronic devices capable of executing applications. For example, a user of a computing device may desire to view an interface of an application on multiple displays (e.g., a first display and a second display). In some examples, it may be desirable for the user to move an interface presented on a first display and to a second display.

When a user moves an interface presented on a first display to a second display, the user may use a mouse or other input device to “drag and drop” the interface from the first display to the second display. In such cases, the user moves the entire interface from the first display to the second display, which takes time and effort on the part of the user. For example, using this “drop and drag” technique, the user moves a cursor of the mouse (or other input device) far enough to move the entire interface from the first display to the second display. The present techniques reduce the time and effort involved to move the interface from the first display to the second display by automatically moving the interface from the first display to the second display responsive to a determination that a portion of the interface moved to the second display exceeds a threshold.

According to an example, a portion of an interface moved from a first display to a second display is determined, the portion is compared to a threshold, and the interface is moved automatically from the first display to the second display responsive to determining that the portion exceeds the threshold. According to another example, an interface is presented on a first display, and the interface is moved automatically from the first display to a second display responsive to receiving a signal from a switcher button. According to yet another example using a first display and a second display, a first interface is presented on the second display, a portion of a second interface moved from the first display to the second display is determined, the portion is compared to a threshold, and the first interface is moved automatically from the second display to the first display and the second interface is moved automatically from the first display to the second display responsive to determining that the portion exceeds the threshold.

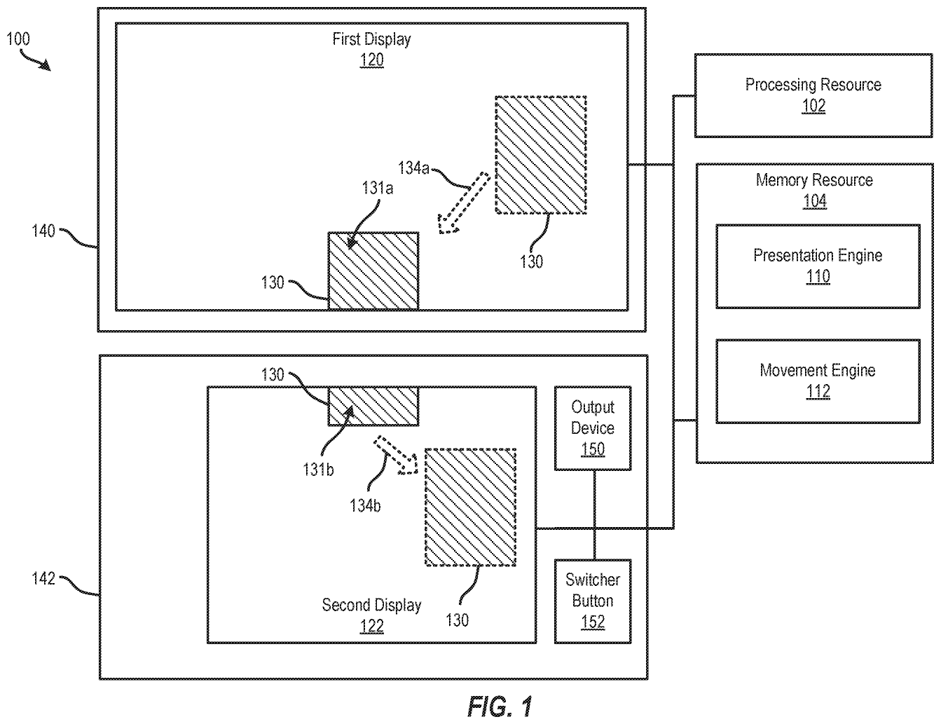

FIGS. 1-3 include components, modules, engines, etc. according to various examples as described herein. In different examples, more, fewer, and/or other components, modules, engines, arrangements of components/modules/engines, etc. can be used according to the teachings described herein. In addition, the components, modules, engines, etc. described herein can be implemented as software modules executing machine-readable instructions, hardware modules, special-purpose hardware (e.g., application specific hardware, application specific integrated circuits (ASICs), field programmable gate arrays (FPGAs), embedded controllers, hardwired circuitry, etc.), or some combination of these.

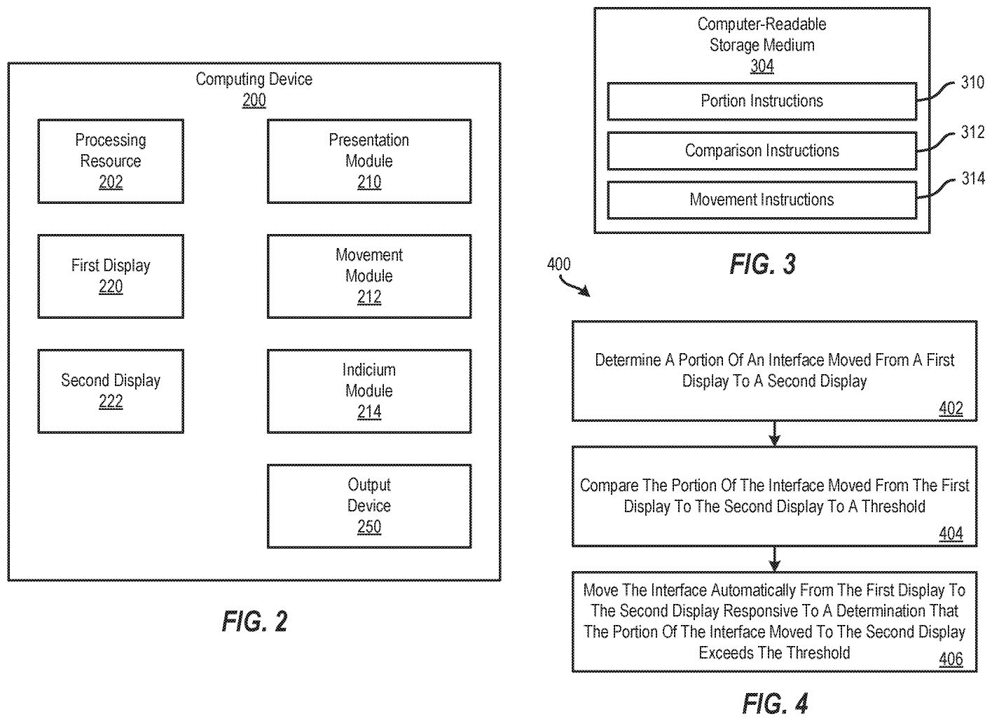

FIGS. 1-3 relate to components and modules of a computing device, such as a computing device 100 of FIG. 1 and a computing device 200 of FIG. 2. In examples, the computing devices 100 and 200 are any appropriate type of computing device, such as smartphones, tablets, desktops, laptops, workstations, servers, smart monitors, smart televisions, digital signage, scientific instruments, retail point of sale devices, video walls, imaging devices, peripherals, networking equipment, wearable computing devices, or the like.

FIG. 1 depicts a computing device 100 having a first display and a second display 122 to present an interface 130 according to examples described herein.

The computing device 100 includes a processing resource 102 that represents any suitable type or form of processing unit or units capable of processing data or interpreting and executing instructions. For example, the processing resource 102 includes central processing units (CPUs), microprocessors, and/or other hardware devices suitable for retrieval and execution of instructions. The instructions are stored, for example, on a non-transitory tangible computer-readable storage medium, such as memory resource 104 (as well as memory resource 204 of FIG. 2 and/or computer-readable storage medium 304 of FIG. 3), which may include any electronic, magnetic, optical, or other physical storage device that store executable instructions. Thus, the memory resource 104 may be, for example, random access memory (RAM), electrically-erasable programmable read-only memory (EPPROM), a storage drive, an optical disk, and any other suitable type of volatile or non-volatile memory that stores instructions to cause a programmable processor to perform the techniques described herein. In examples, memory resource 104 includes a main memory, such as a RAM in which the instructions are stored during runtime, and a secondary memory, such as a nonvolatile memory in which a copy of the instructions is stored.

Alternatively or additionally in other examples, the computing device 100 includes dedicated hardware, such as integrated circuits, ASICs, Application Specific Special Processors (ASSPs), FPGAs, or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

The first display 120 and the second display 122 represent generally any combination of hardware and programming that exhibit, display, or present a message, image, view, interface, portion of an interface, or other presentation for perception by a user of the computing device 100. In examples, the first display 120 and/or the second display 122 may be or include a monitor, a projection device, a touchscreen, and/or a touch/sensory display device. For example, the first display 120 and/or the second display 122 may be any suitable type of input-receiving device to receive a touch input from a user. For example, the first display 120 and/or the second display 122 may be a trackpad, touchscreen, or another device to recognize the presence of points-of-contact with a surface of the first display 120 and/or a surface of the second display 122. The points-of-contact may include touches from a stylus, electronic pen, user finger or other user body part, or another suitable source. The first display 120 and/or the second display 122 may receive multi-touch gestures, such as “pinch-to-zoom,” multi-touch scrolling, multi-touch taps, multi-touch rotation, and other suitable gestures, including user-defined gestures.

The first display 120 and/or the second display 122 can display text, images, and other appropriate graphical content, such as an interface of an application and/or a portion of an interface of an application. In the example shown in FIG. 1, a presentation engine 110 causes the first display 120 and/or the second display 122 to present the interface 130. For example, when an application executes on the computing device 100, the presentation engine 110 presents the interface 130 on the first display 120. The movement engine 112 enables movement of the interface 130 from the first display 120 to the second display 122 and from the second display 122 to the first display 120. For example, using an input device (not shown), a user can move the interface 130 by dragging and dropping the interface 130, by pressing a switcher button 152, or by another suitable technique.

As an example, a user can use a cursor of a mouse (or another suitable input) to select a title bar region (not shown) of the interface 130 and then drag (shown by arrow 134a) the interface 130 from the first display 120 to the second display 122. In such an example, the movement engine 112 determines a portion 131b of the interface 130 moved from the first display 120 to the second display 122. For example, the movement engine 112 determines how much of the interface 130 is moved from the first display 120 to the second 122 as a ratio or percentage between the portion 131b of the interface 130 moved to the second display 122 to a total of the interface 130. In the example of FIG. 1, the portion 131b moved to the second display 122 represents approximately one-third of the interface 130.

The movement engine 112 then compares the portion 131b of the interface 130 moved from the first display 120 to the second display 122 to a threshold. The threshold can be predefined, adjustable, user-defined, and the like. In examples, the threshold can be 10%, 20%, 25%, 30%, 33%, 50%, 51%, 66%, 75%, 90%, or another suitable value.

If the movement engine 112 determines that the portion 131b of the interface 130 moved to the second display 122 exceeds the threshold, the movement engine 112 automatically moves (shown by arrow 134b) the interface 130 from the first display 120 to the second display 122. For example, if the threshold is 33%, and if the movement engine 112 determines that the portion 131b exceeds (or meets) the threshold, the movement engine 112 automatically moves the interface 130 to the second display.

As another example, the user can press the switcher button 152 to cause the interface 130 to move from the first display 120 to the second display 122 or to move from the second display 122 to the first display 120. Similarly, the user can press the switcher button 152 to cause the interface 130 to move from the second display 122 to the first display 120. The switcher button 152, in examples, acts on a selected interface. In other examples, the switcher button 152 can default to moving interfaces from the first display 120 to the second display 122 or can default to moving interfaces from the second display 122 to the first display 120.

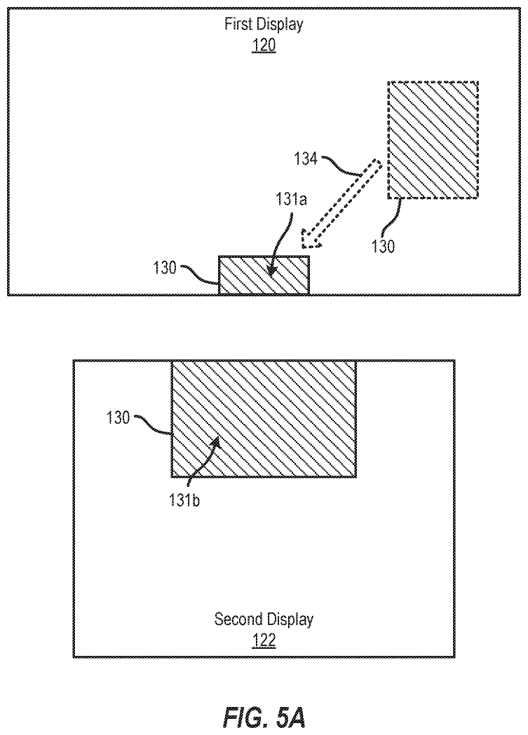

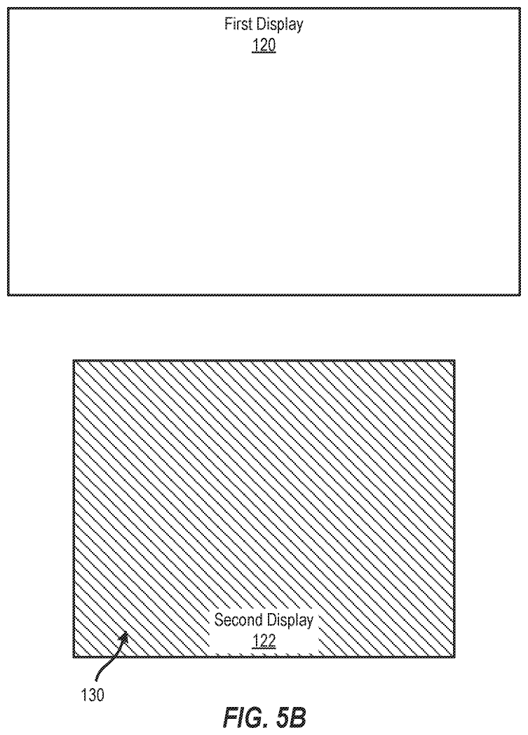

According to some examples, the interface 130 is enlarged when presented on the second display 122 (see, for example, FIGS. 5A and 5B described further herein). Other modifications in addition to enlargement are also possible. For example, the interface 130 can be reduced, stretched in a horizontal direction, stretched in a vertical direction, cropped, rotated, and the like, including combinations thereof.

In the example of FIG. 1, the computing device 100 includes an output device 150, which provides indications responsive to a determination that the portion 131b of the interface 130 moved to the second display 122 exceeds the threshold. The indications can be visual, audible, tactile, and the like, including combinations thereof. For example, the output device 150 is an indicator light that emits light when the threshold is exceeded. In another example, the output device 150 is a speaker that emits a sound when the threshold is exceeded.

According to examples, the first display 120 is disposed in a first housing 140, and the second display 122, the output device 150, and the switcher button 152 are disposed in a second housing 142. In other examples, the second display 122 and/or the output device 150 can be disposed in the first housing 140 instead of the second housing 142. In examples, the first housing 140 and the second housing 142 can be mechanically coupled together, such as by a hinge or other suitable mechanical coupling.

According to an example, the first display 120 has a first size and a first aspect ratio and the second display 122 has a second size and a second aspect ratio. For example, the first display 120 is an approximate 15″ (diagonal) display and the second display 122 is an approximate 6″ (diagonal) display. In other examples, other sizes of displays can be used.

FIG. 2 depicts computing device 200 to present an interface on a first display 220 and on a second display 222 according to examples described herein. Similarly to the computing device 100 of FIG. 1, the example computing device 200 of FIG. 2 includes a processing resource 202, the first display 220, the second display 222, and an output device 250.

Additionally, the computing device 200 includes a presentation module 210, a movement module 212, and an indicium module 214. These modules may be stored, for example, in a computer-readable storage medium or a memory, or the modules may be implemented using dedicated hardware for performing the techniques described herein.

The presentation module 210 presents the interface 130 for an application on the first display 120. The application can be any suitable type of application, such as a game application, a communication application, a productivity application, a social media application, a media player application, and others.

The movement module 212 determines the portion 131b of the interface 130 moved from the first display 120 to the second display 122. The movement module 212 compares the portion 131b of the interface 130 moved from the first display 120 to the second display 122 to a threshold. The movement module 212 then moves the interface 130 automatically from the first display 120 to the second display 122 responsive to a determination that the portion 131b of the interface 130 moved to the second display 122 exceeds the threshold.

The indicium module 214 causes the output device 250 to output an indication that the threshold is exceeded. For example, if the output device 250 is a speaker, the indicium module 214 causes the output device 250 to generate a sound to alert a user that the threshold is exceeded. This is useful to signal the user that the threshold is exceeded so that the user can cease manually moving the interface 130 from the first display 120 to the second display 122. The output device 250, in examples, can be a speaker, light, tactile device, or another suitable device for outputting an indication that the threshold is exceeded.

FIG. 3 depicts a computer-readable storage medium 304 comprising instructions to present an interface (e.g., the interface 130) on a first display (e.g., the first display 120) and on a second display (e.g., the second display 122) according to examples described herein. The computer-readable storage medium 304 is non-transitory in the sense that it does not encompass a transitory signal but instead is made up of memory components that store the instructions. The computer-readable storage medium may be representative of the memory resource 104 of FIG. 1 and may store machine-executable instructions in the form of modules or engines, which are executable on a computing device such as the computing device 100 of FIG. 1 and/or the computing device 200 of FIG. 2.

In the example shown in FIG. 3, the instructions include portion instructions 310, comparison instructions 312, and movement instructions 314. The instructions of the computer-readable storage medium 304 are executable to perform the techniques described herein, including the functionality described regarding the method 400 of FIG. 4. The functionality of these modules is described below with reference to the functional blocks of FIG. 4 but should not be construed as so limiting.

In particular, FIG. 4 depicts a flow diagram of a method 400 that presents an interface (e.g., the interface 130) on a first display (e.g., the first display 120) and on a second display (e.g., the second display 122) according to examples described herein. The method 400 is executable by a computing device such as the computing device 100 of FIG. 1 and/or the computing device 200 of FIG. 2.

At block 402 of FIG. 4, the portion instructions 310 determine a portion of an interface moved from a first display to a second display. At block 404, the comparison instructions 312 compare the portion of the interface moved from the first display to the second display to a threshold. At block 406, the movement instructions 314 move the interface automatically from the first display to the second display responsive to a determination that the portion of the interface moved to the second display exceeds the threshold.

Additional processes also may be included, and it should be understood that the processes depicted in FIG. 4 represent illustrations and that other processes may be added or existing processes may be removed, modified, or rearranged without departing from the scope and spirit of the present disclosure.

For example, the portion instructions 310 determine a second portion of the interface moved from the second display 122 to the first display 120. The comparison instructions 312 compare the second portion of the interface moved from the second display 222 to the first display 120 to the threshold. The movement instructions 314 move the interface automatically from the second display 122 to the first display 120 responsive to a determination (by the comparison instructions 312) that the second portion of the interface moved to the first display 120 exceeds the threshold. According to examples, the instructions of the computer-readable storage medium 304 can be further configured to, responsive to moving the interface automatically from the second display 122 to the first display 120, resize the interface to a known size. The known size can be a previous size, such as the size of the interface prior to moving the interface from the first display 120 to the second display 122. The known size can also be a predetermined or default size, a user-defined size, and the like.

Additionally, the method 400 can include modifying (e.g., enlarging, reducing, etc.) the portion 131b presented on the second display 122. In such examples, the computer-readable storage medium 304 includes modification instructions to modify the portion 131b. For example, FIGS. 5A and 5B depict the first display 120 and the second display 122 of FIG. 1 to present an interface according to examples described herein.

In the example of FIG. 5A, with reference to FIG. 1, the presentation engine 110 presents the interface 130 on the first display 120. A user then initiates moving (shown by the arrow 134) the interface 130 to the second display 122. As shown in FIG. 5A, the portion 131b of the interface 130 is enlarged when moved to the second display 122 relative to the portion 131a of the interface 130 presented on the first display 120. In examples, the portion 131b of the interface 130 is enlarged or reduced based on a size of the second display 122 relative to a size of the first display 120. In another example, the portion 131b of the interface 130 is enlarged or reduced based on a user-defined setting defining how the portion 131b of the interface 130 is enlarged/reduced when moved to the second display 122. For example, a user-defined setting can be set to define how the portion 131b is enlarged or reduced when it is moved from the first display 120 to the second display 122. In an example, the user-defined setting is 150%, defining that the portion 131b is presented at (i.e., enlarged to) 150% of its original size when presented on the second display 122. In another such example, the user-defined setting is 70%, defining that the portion 131b is presented at (i.e., reduced to) 70% of its original size when presented on the second display 122. Other user-defined settings are also possible to determine how the portion 131b of the interface is enlarged/reduced when presented on the second display 122. The portion 131b of the interface 130 can be enlarged or reduced based on combinations of these factors or other factors in other examples.

Once it is determined by the movement engine 112 that the portion 131b exceeds the threshold, the movement engine 112 moves the interface 130 automatically to the second display 122 as shown in FIG. 5B. In this example, the interface 130 is resized (enlarged) to fill the second display 122.

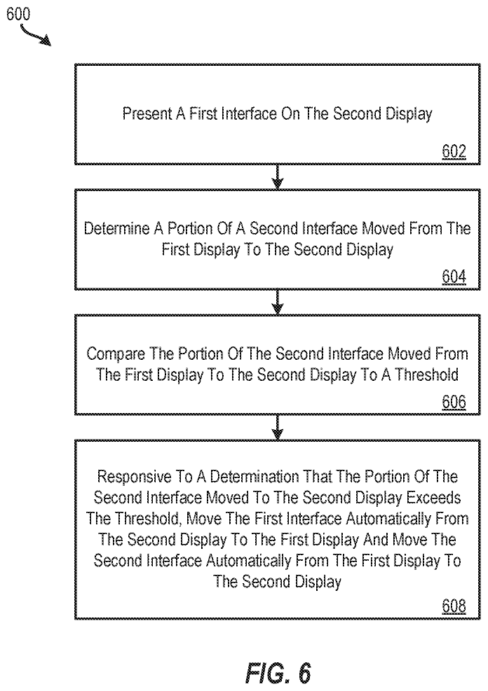

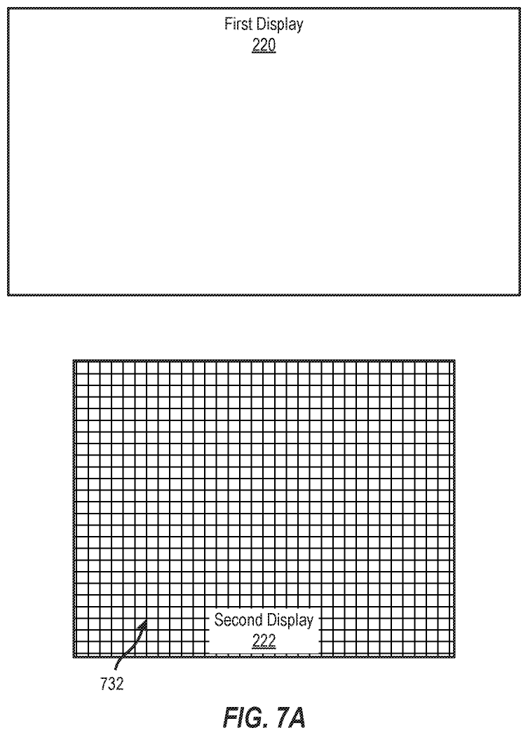

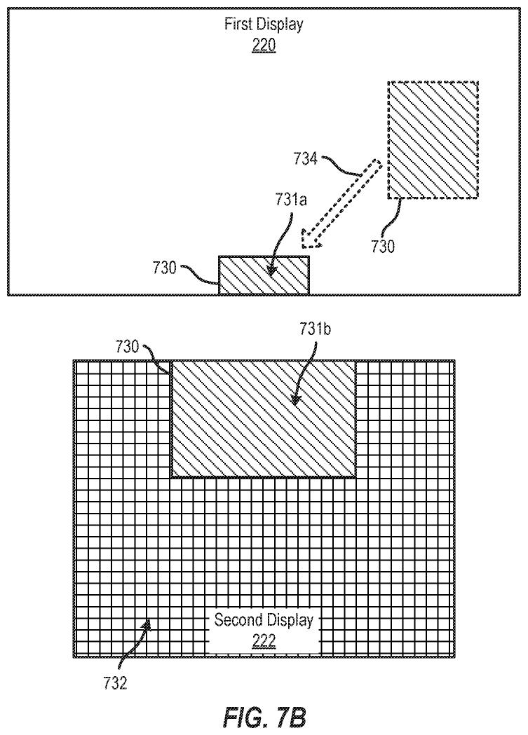

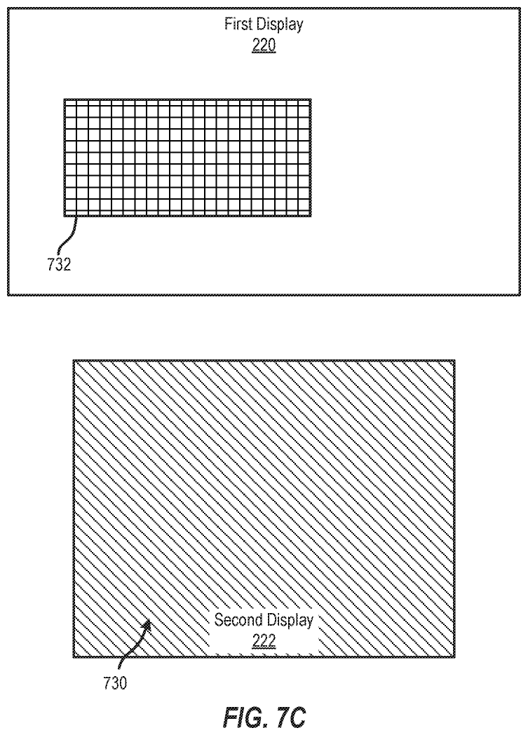

FIG. 6 depicts a flow diagram of a method 600 that presents interfaces 730, 732 on a first display (e.g., the first display 220) and on a second display (e.g., the second display 222) according to examples described herein. The method 400 is executable by a computing device such as the computing device 100 of FIG. 1 and/or the computing device 200 of FIG. 2. The method 600 is described with reference to FIGS. 7A, 7B, and 7C, which depict the first display 220 and the second display 222 of FIG. 2 to present interfaces 730, 732 according to examples described herein.

At block 602, the presentation module 210 presents a first interface 732 on the second display 222 (see FIG. 7A). In the example of FIG. 7A, the first interface 732 is shown as filling the second display 222 (i.e., in a “full screen” mode); however, in other examples, the size of the first interface 732 can be a size other than filling the second display 222.

At block 604, the movement module 212 determines a portion 731b of a second interface 730 moved (shown by arrow 734) from the first display 220 to the second display 222 (see FIG. 7B). A remaining portion 731a of the second interface 730 remains presented on the first display 220.

At block 606, the movement module 212 compares the portion 731b of the second interface 730 moved from the first display 220 to the second display 222 to a threshold.

At block 608, the movement module 212, responsive to a determination that the portion 731b of the second interface 730 moved to the second display 222 exceeds the threshold, moves the first interface 732 automatically from the second display 222 to the first display 220 and moves the second interface 730 automatically from the first display 220 to the second display 222 (see FIG. 7C).

Additional processes also may be included, and it should be understood that the processes depicted in FIG. 6 represent illustrations and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium comprising instructions that, when executed by a processing resource of a computing device, cause the processing resource to:
determine a portion of an interface moved from a first display to a second display;
compare the portion of the interface moved from the first display to the second display to a threshold; and
move the interface automatically from the first display to the second display responsive to a determination that the portion of the interface moved to the second display exceeds the threshold.

2. The non-transitory computer-readable storage medium of claim 1, wherein the instructions further cause the processing resource to, responsive to moving the interface automatically from the first display to the second display, resize the interface to fill the second display.

3. The non-transitory computer-readable storage medium of claim 1, wherein the instructions further cause the processing resource to indicate visually that the portion of the interface moved to the second display exceeds the threshold.

4. The non-transitory computer-readable storage medium of claim 1, wherein the instructions further cause the processing resource to indicate aurally that the portion of the interface moved to the second display exceeds the threshold.

5. The non-transitory computer-readable storage medium of claim 1, wherein the instructions further cause the processing resource to:
determine a second portion of the interface moved from the second display to the first display;
compare the second portion of the interface moved from the second display to the first display to the threshold; and
move the interface automatically from the second display to the first display responsive to a determination that the second portion of the interface moved to the first display exceeds the threshold.

6. The non-transitory computer-readable storage medium of claim 5, wherein the instructions further cause the processing resource to, responsive to moving the interface automatically from the second display to the first display, resize the interface to a known size.

7. The non-transitory computer-readable storage medium of claim 1, wherein the threshold is adjustable.

8. A non-transitory computer-readable storage medium comprising instructions that, when executed by a processing resource of a computing device, cause the processing resource to:
present an interface on a first display; and
move the interface automatically from the first display to a second display responsive to receiving a signal from a switcher button.

9. The non-transitory computer-readable storage medium of claim 8, wherein the first display is disposed in a first housing and the switcher button and the second display are disposed in a second housing.

10. The non-transitory computer-readable storage medium of claim 8, wherein the instructions further cause the processing resource to move the interface automatically from the second display to the first display responsive to receiving a second signal from the switcher button.

11. A computing device comprising:
a first display;
a second display; and
a processing resource to:
present a first interface on the second display;
determine a portion of a second interface moved from the first display to the second display;
compare the portion of the second interface moved from the first display to the second display to a threshold; and
responsive to a determination that the portion of the second interface moved to the second display exceeds the threshold, move the first interface automatically from the second display to the first display and move the second interface automatically from the first display to the second display.

12. The computing device of claim 11, further comprising an indicator light, the processing resource further to:
illuminate the indicator light responsive to a determination that the portion of the second interface moved to the second display exceeds the threshold.

13. The computing device of claim 12, the processing resource further to:
responsive to moving the first interface automatically from the second display to the first display, resize the first interface to a known size.

14. The computing device of claim 12, the processing resource further to:
responsive to moving the second interface automatically from the first display to the second display, resize the second interface to fill the second display.

15. The computing device of claim 11, wherein the first display has a first size, and wherein the second display has a second size, the first size differing from the second size.
